(19) United States
(12) Patent Application Publication
(10) Pub. No.: US 2006/0179978 A1
(43) Pub. Date: Aug. 17, 2006

(54) Jar lid vacuum release tool

(76) Inventor: Leslie Rocks, Orange, CA (US)

Correspondence Address: Donald W. Meeker;Patent Agent, 924 East Ocean Front #E, Newport Beach, CA, 92661, US

(21) Appl. No.: 11/056,969

(22) Filed: Feb. 11, 2005

(51) Int. Cl. B67B 7/16

(52) U.S. Cl. 81/3.55

(57) ABSTRACT

A lever-type jar lid vacuum seal releasing tool with a rounded thin upwardly bent lip for slipping between a jar lid and a jar and a resilient bumper fulcrum point contacting the jar that prevents breakage of the jar while releasing the vacuum seal.

### BACKGROUND OF THE INVENTION

1. Field of the Invention

The present invention relates to jar openers and particularly to a lever-type vacuum seal-cracking tool for jars, which has a resilient bumper fulcrum point that prevents breakage of the jar while loosening the vacuum seal on the jar lid.

2. Description of the Prior Art

Everyone has at one time encountered a jar they could not open. The jars that we purchase at the local supermarket have vacuum-sealed lids to maintain the freshness of the jar's contents. Unfortunately, the process of sealing the jar lid can often lead to a seal that is extremely difficult to break. If a person is physically unable to open a lid on a jar, they will either have to seek out someone who can open the jar, or go without opening it. Consequently, there is a need for a jar opener, which will enable any user to easily open most twist top jar lid.

Jar lids are easy to open and close after the vacuum seal has been broken. Because jars are usually breakable made of glass or plastic, it is important not to break the jar while attempting to open the lid. The prior art patents fail to address the problem adequately.

Prior art U.S. Pat. No. 2,503,683, issued Apr. 11, 1950 to Perkins, discloses a tool for loosening screw caps on jars, which comprises a handle having at an end thereof a tapered strip of stiff metal with down-turned lateral flanges and an upturned nose at the extremity thereof. The nose extends approximately at right angles to the plane of the tapered strip and is thinner than the stock thickness of the strip. Alternately, the tool may comprise a tapered end portion terminating in a short thin nose bent up at right angles to the tapered portion. The tapered portion of the strip has downwardly bent side flanges, the edges of which curve near the nose to meet the side edges of the nose and to serve as a fulcrum when the tool is used.

Prior art U.S. Pat. No. D325,500, issued Apr. 21, 1992 to Dennis, claims the ornamental design for the vacuum seal-cracking tool for jars.

Prior art U.S. Pat. No. D369,532, issued May 7, 1996 to Scutt, shows the ornamental design for a jar lid lifter.

Prior art U.S. Pat. No. D119,264, issued Mar. 5, 1940 to Hildebrand, is for the ornamental design of a jar opener.

Prior art U.S. Pat. No. 2,624,220, issued Jan. 6, 1953 to Cassiere, describes a pry type vacuum cap remover that comprises a cap remover for a container employing a cap having a friction grip about the mouth of a container. The cap remover comprises a handle portion that has a pair of projections at one end, said projections are spaced by a recessed portion, which permit the projections to be placed beneath the cap at spaced points. The device also comprises a fulcrum struck down from the handle portion and formed inwardly from the edge of the recessed portion.

Prior art U.S. Pat. No. 1,803,171, issued Apr. 28, 1931 to Charlestream, concerns a device for opening jars which are sealed by a gasket, which comprises a shank that has its opposite faces beveled to the end thereof, whereby the end is sharpened. The end is extended laterally from the shank to provide an enlargement. One of the beveled faces of the shank has a longitudinal groove extending through its widened and pointed end. The end has a transverse groove that intersects the longitudinal groove, for the purpose of breaking the vacuum seal of the jar.

Prior art U.S. Pat. No. 2,483,830, issued Oct. 4, 1949 to Hughes, shows a lever-type jar opener that has a relatively broad body and an edge portion of concave arcuate shape. Prongs project inwardly from the ends of the arcuate portion in a substantially radial direction. The prongs have upwardly turned ends to enter between the cap flange and the jar. A toe member projects from the center of the arcuate portion and curves downwardly from the arcuate portion of the tool body.

Prior art U.S. Pat. No. 6,378,398, issued Apr. 30, 2002 to Brix-Hansen, provides a tool for breaking a vacuum in a preserving jar that is closed with a screw cap circular lid. The tool is provided with an oblong handle, which at one end has a portion for engaging the cap of a preserving jar, and a jaw for engaging the lower edge of the cap. The mouth of the jaw is turned away from the other end of the handle, and between the free end of the jaw and the portion for engaging the cap a concave, circular cylindrical guide slot is provided for guiding the tool into position against the rim of the cap in such a way that the jaw grips the lower edge of the cap, after which a slight lifting of the handle brings about an elastic deformation of the rim of the cap allowing the vacuum in the preserving jar to be broken.

Prior art U.S. Pat. No. 1,432,670, issued Oct. 17, 1922 to Cole, puts forth a jar opener that comprises a lever with one end adapted to be inserted under the cover of a jar, which is provided with an offset open loop adapted to receive and hold the cover clamp of the jar so that the same may be used as a fulcrum during the opening operation.

Prior art U.S. Pat. No. D42,601, issued Jun. 11, 1912 to Ferrall, illustrates the ornamental design of a tool for removing seals.

What is needed is an easy to use inexpensive tool which provides a long lever arm for adequate leverage to enable persons with little manual strength or gripping ability to operate the tool for releasing a vacuum seal on a jar lid with a provision in the tool for protecting the integrity of the jar.

### SUMMARY OF THE INVENTION

An object of the present invention is to provide an easy to use inexpensive tool which provides a long lever arm for adequate leverage to enable persons with little manual strength or gripping ability to operate the tool for releasing a vacuum seal on a jar lid with a resilient bumper at the pivot point for protecting the integrity of the jar to prevent cracking or breaking of the jar.

Another object of the present invention is to provide a jar lid vacuum release tool with a thin rounded tip, which slips under any jar lid easily.

One more object of the present invention a jar lid vacuum release tool that has an enlarged rubber bumper, which protects a jar during entire lever operation and provides extra leverage in spacing the tool further away from the jar at the pivot point.

An additional object of the present invention is to provide a jar lid vacuum release tool with a lever arm formed of stainless steel, which is dishwasher safe.

In brief, a lid vacuum release tool for screw top lids vacuum sealed on jars, which comprises a rigid elongated lever arm formed of a flattened strip of stainless steel bent at the distal end. The lever arm has a rubberized hand grip located at a proximal end, which extends outwardly from the lever arm a sufficient distance to enable a hand of a user to fit around the hand grip. The lever arm further comprises a thin rounded tip angled upwardly from the lever arm at a distal end. The thin rounded tip is adapted to slip between a jar lid and a jar under the rim of the jar.

The lid vacuum release tool also comprises a convexly curved molded rubber bumper attached to and protruding downwardly from the lever arm spaced apart from the rounded tip adjacent to the distal end. The lever arm is bent downwardly for the length of the resilient bumper and the rounded tip curves upwardly from a distal end of the resilient bumper. The resilient bumper provides a pivot point for the lever arm and prevents scratching, cracking or breaking of the jar. The outer resilient surface of the bumper maintains contact with the jar during an entire lever movement causing a release of a vacuum between a jar lid and a jar.

The tip of the lid vacuum release tool is placed under the lip or edge of the lid, between the jar rim and the lid with the outer surface of the rubber bumper contacting the side of the jar. Once the tip is in place, a simple and effortless downward motion of the hand grip will pry the side of the lid just enough to break the vacuum seal which releases the pressure causing the tightness between the lid and the jar. The lid may then be easily turned and removed from the jar without excessive hand strength. The lid vacuum release tool provides adequate leverage to enable persons with little manual strength and gripping ability to operate the tool to release a vacuum seal on a jar lid. The lid vacuum release tool is beneficial to many people including elderly or arthritic persons, who may have decreased hand strength. The tool decreases, if not eliminates the stress put on the fingers, wrists and/or hands while trying to twist the lid off of a vacuum pack sealed jar.

An advantage of the present invention is that it enables persons with little manual strength or gripping ability to open a jar.

Another advantage of the present invention is that it is inexpensive.

An additional advantage of the present invention is that it does not use electricity.

One more advantage of the present invention is that it will not damage the jar.

Yet another advantage of the present invention is that it is simple to use.

Still another advantage of the present invention is that it is dishwasher safe.

A further advantage of the present invention is that it takes up little storage space in the utensil drawer.

Another advantage of the present invention is that is has an aesthetically pleasing form.

A corollary advantage of the present invention is that it does not distort the shape of the lid.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is a side elevational view of the lid vacuum release tool of the present invention;

FIG. 2 is a perspective view of the lid vacuum release tool of FIG. 1;

FIG. 3 is a side elevational view of the present invention with the rounded tip inserted between a jar lid and a jar with the resilient bumper resting on the jar for leverage.

### BEST MODE FOR CARRYING OUT THE INVENTION

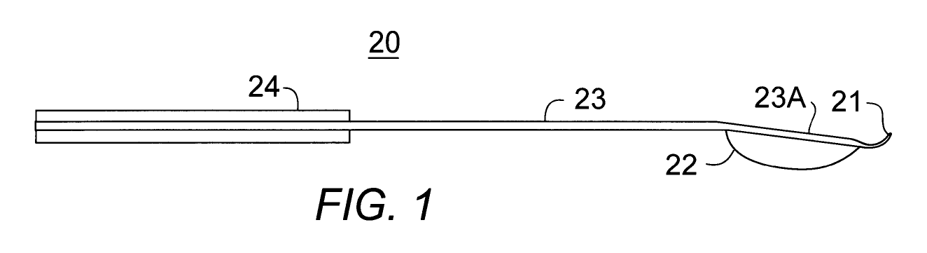

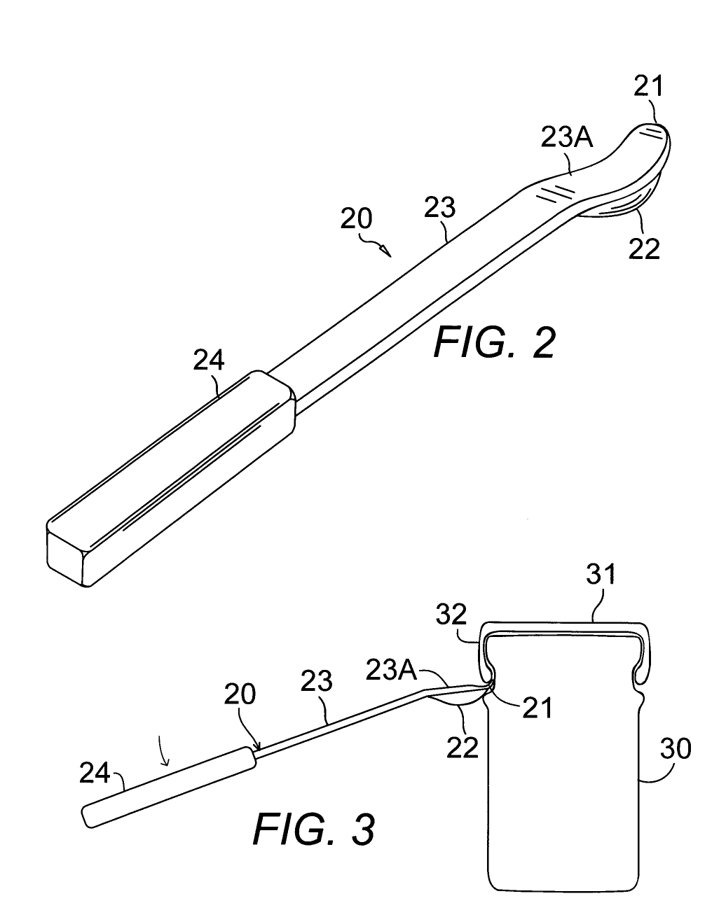

In FIGS. 1-3, a lid vacuum release tool 20 for screw top lids 31 vacuum sealed on jars 30, which comprises a rigid elongated lever arm 23 formed of a flattened strip of stainless steel bent at the distal end. The lever arm 23 has a hand grip 24 located at a proximal end. The hand grip 24 comprises a rubberized covering around the proximal end of the lever arm 23 extending outwardly from the lever arm 23 a sufficient distance to enable a hand of a user to fit around the hand grip 24 in a firm yet comfortable grip appropriate for people with arthritis or other limiting manual dexterity problems. The lever arm 23 further comprises a thin rounded tip 21 angled upwardly from the lever arm 23 at a distal end, seen in FIGS. 1 and 2. The thin rounded tip 21 is adapted to slip between a jar lid 31 and a jar 30 under the jar lid rim 32, as shown in FIG. 3.

The lid vacuum release tool 20 also comprises a resilient bumper 22 attached to and protruding downwardly from the lever arm 23 spaced apart from the rounded tip 21 adjacent to the distal end. The resilient bumper 22 comprises a piece of rubberized material securely attached to an underside of the lever arm 23, and is preferably formed of molded rubber adhered or otherwise permanently secured to the lever arm 23. The resilient bumper 22 has a convexly curved outer resilient surface spaced apart from the lever arm 23 a sufficient distance to increase the leverage power of the lever arm 23 so that the lever arm 23 may release a vacuum seal on a jar lid 31 with little force on the hand grip 24 of the lever arm 23. The lever arm 23 has a downwardly bent section 23A for the length of the resilient bumper 22 and the rounded tip 21 curves upwardly from a distal end of the resilient bumper 22.

In use, the resilient bumper 22 contacts the jar 30 with the rounded tip 21 inserted between a jar lid 31 and the jar 30 so that the resilient bumper 22 provides a pivot point for the lever arm 23, as shown in FIG. 3. The outer resilient surface of the bumper 22 maintains contact with the jar 30 and protects the jar 30 during the entire lever movement causing a release of a vacuum between a jar lid 31 and a jar 30. The resilient bumper 22 protects the integrity of the jar 30 to prevent cracking and breaking of the jar 30.

The lid vacuum release tool 20 provides adequate leverage to enable persons with little manual strength and gripping ability to operate the tool 20 to release a vacuum seal on a jar lid 31.

In practice, the tapered pry-up tip 21 of the jar lid vacuum release tool 20 is placed under the lip or edge of the lid 31, between the jar lid rim 32 and the jar 30 with the outer surface of the rubber bumper 22 contacting the side of the jar 30, as shown in FIG. 3. Once the tip 21 is in place, a simple and effortless downward motion of the hand grip 24 will pry the jar lid rim 32 of the lid 31 just enough to break the vacuum seal which releases the pressure causing the tightness between the lid 31 and the jar 30. The lid 31 may then be easily turned and removed from the jar 30 without excessive hand strength required.

It is understood that the preceding description is given merely by way of illustration and not in limitation of the invention and that various modifications may be made thereto without departing from the spirit of the invention as claimed.

What is claimed is:

1. A lid vacuum release tool for screw top lids vacuum sealed on jars, the tool comprising:
a rigid elongated lever arm having a hand grip at a proximal end and a thin rounded tip angled upwardly from the lever arm at a distal end, the thin rounded tip adapted to slip between a jar lid and a jar;
a resilient bumper attached to and protruding downwardly from the lever arm spaced apart from the rounded tip adjacent to the distal end, the resilient bumper adapted to contact a jar with the rounded tip inserted between a jar lid and the jar so that the resilient bumper provides a pivot point for the lever arm, the resilient bumper adapted to protect the integrity of the jar to prevent cracking and breaking of the jar, the lid vacuum release tool being adapted to provide adequate leverage to enable persons with little manual strength and gripping ability to operate the tool to release a vacuum seal on a jar lid.

2. The tool of claim 1 wherein the resilient bumper comprises a piece of rubberized material securely attached to an underside of the lever arm, the resilient bumper having a convexly curved outer resilient surface spaced apart from the lever arm a sufficient distance to increase the leverage power of the lever arm so that the lever arm is adapted to release a vacuum seal on a jar lid with little force on the hand grip of the lever arm, the outer resilient surface being adapted to maintain contact with the jar and protect the jar during an entire lever movement causing a release of a vacuum between a jar lid and a jar.

3. The tool of claim 2 wherein the lever arm is bent downwardly for the length of the resilient bumper and the rounded tip curves upwardly from a distal end of the resilient bumper.

4. The tool of claim 1 wherein the hand grip comprises a rubberized covering around the proximal end of the lever arm extending outwardly from the lever arm a sufficient distance to enable a hand of a user to fit around the hand grip.

5. The tool of claim 1 wherein the lever arm is formed of a flattened strip of stainless steel bent at the distal end.

6. The tool of claim 1 wherein the resilient bumper is formed of molded rubber adhered to the lever arm.
